(19) United States
(12) Patent Application Publication
(10) Pub. No.: US 2012/0189868 A1
(43) Pub. Date: Jul. 26, 2012

(54) Process for the preparation of a coated substrate, coated substrate, and use thereof

(75) Inventors: Alexander Sergeevich Borovik, Houston, TX (US); Dennis Leon Deavenport, Houston, TX (US); Jörg Heller, Engelskirchen (DE); Boris Kuzmanovic, Utrecht (NL); Arthur Robert Luttmer, Almelo (NL); Simon Oberhauser, Rohrbach (DE)

(73) Assignee: AKZO NOBEL CHEMICALS INTERNATIONAL B.V., Amersfoort (NL)

(21) Appl. No.: 13/387,440

(22) PCT Filed: Jul. 28, 2010
(86) PCT No.: PCT/EP2010/060929

§ 371 Date: Apr. 13, 2012

Related U.S. Application Data
(60) Provisional application No. 61/230,265, filed on Jul. 31, 2009.

(30) Foreign Application Priority Data
Aug. 12, 2009 (EP) 09167692.4

(51) Int. Cl. B32B 15/01; B05D 3/02

(52) U.S. Cl. 428/615; 427/383.7

(57) ABSTRACT

The invention relates to a process for preparing a substrate with a multizone metallic coating comprising the steps of heating a metallic material optionally comprising a metallic outer layer having a different composition than said metallic material, to a temperature T1, depositing a coating of aluminium, magnesium, and/or zinc, and cooling down to a temperature T2 and continuing the deposition. It furthermore relates to a substrate with a multizone metallic coating obtainable with said process.

The invention relates to a process for preparing a substrate with a multizone metallic coating via metal-organic chemical vapour deposition. It furthermore relates to the resulting substrate having a multizone metallic coating and to the use of such substrates.

Many metal substrates, such as fasteners, screws, nails, metal sheets, automobile parts, and the like, are coated with metallic coatings, preferably including aluminium, to make them corrosion resistant and improve their ability to withstand aggressive media such as chlorine, neutral media, biodiesel, alcohol, fuel, or cooling fluids. Various techniques are known in the art for deposition of metal films on metal substrates. Physical vapour deposition (PVD), for example, is a technique used in the art to deposit thin metal films onto various surfaces by physical means, but it requires extensive deposition equipment which is difficult to operate and maintain. Other ways of depositing thin metal films on substrates are via galvanic metal deposition or by dipping substrates into molten metal.

U.S. Pat. No. 3,652,321 describes a process for the deposition of aluminium on a galvanized surface, comprising the steps of heating the galvanized substrate to a temperature below the melting point of the galvanize and dipping it into a precursor in liquid form to deposit a thin coating of aluminium metal thereon.

It was found, however, that such a deposition method gave poor adherence of the metal coating to the substrate as well as poor layer structure. Furthermore, this method has issues with temperature control due to the unavoidable cooling of the substrate by repeated immersion into the cold liquid precursor, deposition layer thickness control due to the necessity to repeat the dipping steps, and process design equipment requirements.

US 2002/0092586 describes a metal substrate and a multi-layer resistance coating disposed over the metal substrate. The coating is operable to resist corrosion and hydrogen embrittlement of the metal substrate. The coating includes a first layer comprising a material galvanically similar to the metal substrate. It may be applied using plating, plasma spray, flame plating, thermal spray, arc wire spraying, ion vapour deposition, high velocity oxygen flame, sputtering, vapour deposition, mechanical deposition, and laser deposition techniques. The coating also includes a second layer disposed over the first layer using one of the above-mentioned techniques. The second layer comprises a metal anodic to the metal substrate. The corrosion-resistant article may also include a corrosion-resistant interface layer at the boundary of the first and second layers. This interface layer may be formed by diffusing a portion of the second layer into the first layer by heating the article after application of both layers while subjecting it to a non-oxidizing atmosphere.

Metal-Organic Chemical Vapour Deposition (MOCVD) is a technique used in the art to deposit thin metal films on substrates. In a typical MOCVD process, the substrate is exposed to one or more volatile metal-containing precursors, which react and/or decompose on the substrate surface to produce the desired deposit. An advantage of a MOCVD deposition process compared to non-CVD alternative metal coating methods is that the MOCVD process allows for the effective coating of complex shapes with small features and patterns, such as openings, crevices, lines, dents, dimples, pits, and indentions, as well as internal surfaces of the objects such as pipes or inner threads, due to the nature of the precursor diffusion in the vapour phase.

A MOCVD method for depositing a substantially pure, conformal metal layer on substrates in bulk quantities through the decomposition of a metal-containing precursor is described in WO 2005/028704. During the described deposition process, the substrates are maintained at a temperature greater than the decomposition temperature of the precursor while the surrounding atmosphere is maintained at a temperature lower than the decomposition temperature of the precursor.

It is an object of the present invention to provide a metal coated substrate with improved corrosion resistance and improved adhesion of the metal coating to the substrate. Furthermore, it is an object of the present invention to provide a straightforward and time-efficient process for preparing such a metal coated substrate.

It was found that the objects of the present invention are realized by preparing a substrate with a multizone metallic coating using chemical vapour deposition wherein deposition and diffusion take place simultaneously. In more detail, the present invention concerns a process for preparing a substrate with a multizone metallic coating comprising the steps of (i) heating a metallic material optionally comprising a metallic outer layer having a different composition than said metallic material to a temperature T1, (ii) at T1, depositing over a period of between 10 seconds and 12 minutes a coating of aluminium, magnesium, and/or zinc onto said metallic material via metal organic chemical vapour deposition using one or more metal-containing precursors selected from the group consisting of aluminium-containing precursors and/or magnesium-containing precursors and/or zinc-containing precursors, with T1 being a temperature at which the rate of diffusion of the deposited metal(s) and metal(s) of the metallic material and/or metallic outer layer is higher than or equal to the deposition rate of the deposited metal(s) but which is lower than the melting point of the metallic material or the metallic outer layer, or which is lower than the melting point of the formed metallic coating, whichever melting point is the lowest, with the proviso that the metal composition at the exterior of the metallic material is not identical to the composition of the deposited metal(s), and (iii) cooling down to a temperature T2 and continuing the deposition, with T2 being a temperature at which the rate of diffusion of the metals is equal to or lower than the deposition rate of the metal(s), but which is at least a temperature at which the deposition rate of the metal(s) being deposited is higher than 0.2 μm per minute.

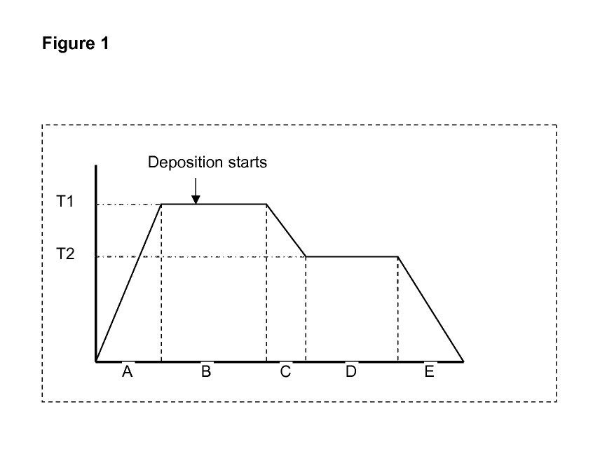

The present invention will now be elucidated with reference to a schematic representation of a preferred embodiment of the above-disclosed process as given in FIG. 1. However, the invention should not be deemed limited thereto or thereby. The process can be divided into five stages. In a stage (A) the metallic material is heated until temperature T1 is reached (i.e. step (i) of the present process). Heating can be done gradually or step by step. Deposition can start immediately after having reached T1. However, it is also possible to keep the temperature at T1 for some time before deposition is started (i.e. before step (ii) takes place). This is indicated as stage B in FIG. 1. In a next stage, stage C in FIG. 1, the temperature is lowered to reach temperature T2. At T2, deposition is continued (i.e. step (iii) of the process according to the present invention). This is indicated as stage D in FIG. 1. Stage C can be kept very short, by cooling down rapidly, or cooling can be done very slowly. It is possible to stop the deposition at the end of stage B, and resume deposition only after temperature T2 is reached. However, it is preferred to continue with the deposition during stage C as well. After step (iii) has been completed, the substrate is cooled down, indicated as stage E in FIG. 1. Cooling down can also be done gradually or step by step. In a preferred embodiment, the deposition is stopped at the end of step D by simultaneously stopping the supply of metal-containing precursor and reducing the temperature significantly below T2.

Besides the improved adhesion, the process according to the present invention has a couple of advantages. Depending on the type of multizone coating which is deposited on the surface of the substrate, the coated substrates according to the invention have better stability in corrosive conditions, such as those where contact corrosion occurs, better cathodic protection for steel, the rate of dissolution in aggressive media such as chlorine, neutral media, biodiesel, alcohol, fuel, or cooling fluids is significantly lowered, they have improved weldability and/or they can be used in a larger pH range compared to substrates having a coating via conventional methods. Furthermore, by executing diffusion and deposition simultaneously, a straightforward and time-efficient process is provided.

By the term “multizone metallic coating” as used throughout the description is meant a metallic coating which comprises at least two different metals and which does not have a uniform composition, but which comprises one or more metallic layers with at least one layer having a gradual composition of the metals as a result of intermetallic diffusion of said metals.

The substrate to be coated according to the present invention can be any metallic material which is able to withstand the metal-containing precursor used and temperatures applied. The metallic material can be metallized, i.e. it can comprise a metallic layer on its surface. It is noted that the composition of the metallic layer on the surface of the metallic material differs from the composition of the metallic material. Such a material is hereinafter also denoted as “metallized material”.

The substrate according to the present invention is preferably a metallic core selected from the group consisting of unalloyed steel, low alloyed steel, high alloyed steel, iron, cast iron, copper, a copper alloy, nickel, a nickel alloy, titanium, a titanium alloy, alpha-titanium, beta-titanium, alpha-beta-titanium, gamma-titanium-aluminium, aluminium, cast aluminium, an aluminium alloy, magnesium, cast magnesium, a magnesium alloy, cobalt, a cobalt alloy, zinc, cast zinc, a zinc alloy, tin, and chromium. Preferably, it is steel.

The metallic material is optionally metallized, which means that it comprises a metallic layer on its surface which is preferably selected from the group consisting of zinc, a zinc-nickel alloy, a zinc-iron alloy, a zinc-tin alloy, a zinc-chromium alloy, a zinc-magnesium alloy, a zinc-aluminium alloy, a zinc-aluminium-magnesium alloy, and magnesium, but which is different in composition from the composition of the metallic material. The metallic layer can also be a Galfan® or Galvalume® layer.

The metallic layer of the metallized material preferably has a thickness of 0.1 μm up to 1,000 μm, more preferably 0.5 up to 500 μm or even more preferably 1 up to 100 μm. Said metallic layer can be applied using processes such galvanic, hot-dip, PVD or CVD techniques, or electroplating techniques involving the use of ionic liquids, mechanical deposition, cladding, explosion-cladding, sheradizing, laser deposition.

Suitable substrates include small assembly parts, such as fasteners, nuts, bolts, screws, nails, rivets, pins, clamps, ferrules, clips, tags, steel, aligning disks, balls. Also, the suitable substrates can be larger assembly parts, such as (automobile) gearbox parts, (automobile) suspension parts, wheel rims, exhaust manifolds, brake discs, metal sheets. Furthermore, the suitable substrates include wire, tubes, and metal coil. There is no limitation as to the size of the substrates except for those imposed by the equipment at hand.

The term “metal-containing precursor” used throughout this specification is meant to include any organometallic compound or organometalloid complex of which it is known in the art that they can be used as MOCVD precursors (see for instance the Handbook of Chemical Vapour Deposition (CVD), Principles, Technology, and Applications, 2^{nd} Edition, Hugh O. Pierson, 1999, by Noyes Publications/Willian Andrew Publishing, New York, Chapter 4 entitled “Metallo-Organic CVD (MOCVD)”.

The metal-containing precursor is preferably selected from the group consisting of metal alkyls, alkyl metal hydrides, metal alkylamides, metal hydride-amine complexes, and volatile organometallics comprising one or more cyclopentadienyl ligands. Preferably, the metal-containing precursor is an aluminium alkyl compound, a zinc alkyl compound, or a magnesium alkyl compound.

Suitable sources for deposition of an aluminium layer include a metal alkyl compound, such as trimethylaluminium, triethylaluminium, dimethylaluminium hydride, tri-n-butylaluminium, triisobutylaluminium, diethylaluminium hydride, diisobutylaluminium hydride, or other trialkylaluminium or alkylaluminium hydride molecules of the formula R¹R²R³Al, wherein R¹, R², and R³ are branched, straight chain, or cyclic hydrocarbyl ligands or hydrogen (with the proviso that R¹, R², and R³ are not all hydrogen), and wherein the number of carbon atoms in R¹, R², and R³ ranges from C₁ to C₁₂. The chosen ligands may also include those such as isoprenyl which are bifunctional and which bond to two or three aluminium atoms. The selected precursor compositions may contain mixtures of any or all of the above-mentioned species. Preferably, R¹, R², and R³ as described above are selected from the group consisting of ethyl, isobutyl, and hydrogen, with the most preferred compounds being triethylaluminium, triisobutylaluminium, diisobutylaluminium hydride or mixtures thereof.

Suitable sources for deposition of a zinc layer include dimethyl zinc, diethyl zinc, di-n-butyl zinc, di-isobutyl zinc, and other dialkylzinc compounds of the formula R⁴—Zn—R⁵, wherein R⁴ and R⁵ are branched, straight chain or cyclic hydrocarbyl ligands, and wherein the number of carbon atoms in R⁴ and R⁵ ranges from C₁ to C₁₂.

Suitable sources for deposition of a magnesium layer include dicyclopentadienyl magnesium, butylethyl magnesium, di-n-octyl magnesium, diphenyl magnesium, and other dialkylmagnesium compounds of the formula R⁶—Zn—R⁷, wherein R⁶ and R⁷ are branched, straight chain or cyclic hydrocarbyl ligands, and wherein the number of carbon atoms in R⁶ and R⁷ ranges from C₁ to C₁₂.

In step (i) of the present process, the metallic material, optionally comprising a metallic outer layer, is heated to a temperature T1. The rate of heating the substrate is preferably at least 1° C. per minute. Preferably, the substrate is not heated at a rate higher than 200° C. per minute. This step is performed to improve adhesion of the metallic layer to the metallic material in the case of a metallized material, to homogenize the metallic material if it is an alloy, or to degas the metallic material in case of a cast alloy. Hence, preferably, the metallic material is heated at a rate of between 1 and 100° C. per minute. As described above, heating can be performed gradually or step by step. In the case of several heating steps, different heating rates can be applied. Step (i) is preferably performed over a period of maximally 48 hours, preferably maximally 10 hours, more preferably maximally 1 hour, and most preferably maximally 30 minutes.

As explained above, T1 is a temperature at which the rate of diffusion of the deposited metal(s) and metal(s) of the metallic material and/or metallic outer layer is higher than the deposition rate of the deposited metal(s) but which is lower than the melting point of the metallic material or the metallic outer layer, or which is lower than the formed metallic coating, whichever melting point is the lowest, with the proviso that the metal composition at the exterior of the substrate is not identical to the composition of the deposited metal(s). Preferably, however, T1 is at least 1° C., more preferably at least 5° C., most preferably at least 10° C. lower than the melting point of the metallic material or the metallic outer layer, or which is at least 1° C., more preferably at least 5° C., most preferably at least 10° C. lower than the formed metallic coating, whichever melting point is the lowest.

The ratio of the rate of diffusion of the deposited metal(s) and metal(s) of the metallic material and/or metallic outer layer to the rate of deposition of the metal(s) deposited by MOCVD is determined by elemental analysis of the generated multizone metallic coating as a function of depth. The chemical composition was analyzed by scanning electron microscopy (SEM) outfitted with Energy-Dispersive X-ray spectroscopy detector (EDX).The rate of diffusion is determined to be higher than or equal to the rate of deposition when at the surface of the metallic material the metals of the metallic material, or of its metallic outer layer in the case of a metallized metallic material, are found. If only metal(s) deposited by MOCVD are found on the surface, the rate of deposition is higher than the rate of diffusion. If a metal-containing precursor is used comprising a metal which is also present in the metallic core and/or metallic outer layer, the above method cannot be used. Instead the ratio of the rate of diffusion of the deposited metal(s) and metal(s) of the metallic core and/or metallic outer layer to the rate of deposition of the metal(s) deposited by MOCVD is determined by elemental analysis of trace materials present in the metallic core and/or metallic outer layer.

As the skilled person will recognize, the optimum temperature range is dependent on the metal-containing precursor used and the characteristics of the substrate to be coated. For example, when using triethylaluminium as precursor and steel plated with zinc as metallic material, temperature T1 preferably is at least 340° C., more preferably at least 350° C., and most preferably at least 360° C. The temperature of the metallic material preferably is at most 400° C., more preferably at most 380° C., and most preferably at most 370° C. For zinc deposition using zinc alkyl compounds, suitable temperatures are generally lower, typically in the range of 260-340° C. For magnesium deposition using butylethyl magnesium alkyl-based precursors, typically T1 temperatures above 370-420° C. will be necessary for the metallic material.

As explained above, T2 is a temperature at which the rate of diffusion of the metals is equal to or lower than the deposition rate of the metal(s), but which is at least a temperature at which the deposition rate of the metal(s) being deposited is higher than 0.2 μm per minute. In other words, in step (iii) of the present process, active deposition is performed, i.e. with an active supply of metal-containing precursor.

The ratio of the rate of diffusion of the deposited metal(s) and metal(s) of the metallic material and/or metallic outer layer to the rate of deposition of the metal(s) deposited by MOCVD is determined as mentioned above.

Typically, temperature T2 applied in step (iii) is approximately 20° C. lower than temperature T1 applied in step (ii). In the case of triethylaluminium as precursor and steel plated with zinc as metallic material, the temperature of the metallic material (T2) is preferably at least 300° C., more preferably at least 320° C. For zinc deposition using zinc alkyl compounds, suitable temperatures are generally lower, typically in the range of 200-300° C. For magnesium deposition using butylethyl magnesium alkyl-based precursors, typically temperatures between 350 and 400° C. are applied.

Taking the guidelines given above into account, it is well within the scope of the skilled person to determine the optimum values for T1 and T2.

A number of methods can be used for heating the substrate. More particularly, the substrate can be heated using a direct heating method, an indirect heating method, or a combination of both. By the term direct heating is meant that the substrate is heated by direct contact between the substrate and the heating source. Examples of direct heating are contacting with a hot inert gas such as a flow of hot nitrogen or hot argon. It also includes electrical resistance heating (flow of the electrical current through the substrate and heating it due to electrical resistance). By the term indirect heating is meant that the substrate is heated without direct contact between a heating source and the substrate. Preferred indirect (“non-contact”) heating methods include heating of the substrate induced by electromagnetic induction, or by irradiation with microwave or IR radiation or by laser heating. Also, focused (localized) heating of specific location(s) can be applied instead of heating the whole substrate, by any of the above-mentioned means, if different multizone metallic coatings are desired at different positions of the substrate.

During step (ii) and step (iii) of the process according to the present invention, i.e. the steps wherein the multizone coating is formed by aid of MOCVD, the substrate is preferably surrounded by a suitable transport medium comprising a metal-containing precursor. Preferred transport media include a substantially saturated vapour, a substantially saturated vapour containing liquid droplets, or a non-saturated vapour containing liquid droplets. Besides the precursors, the transport medium may include delivery vehicles for the precursor such as inert gases, solvents, etc., as well as decomposition products such as saturated or unsaturated hydrocarbons, hydrogen, and other volatile compounds. The transport medium can comprise a volatile solvent such as hexane or heptane, since they aid dispersion of the spray droplets into micro-fine droplets and improving the vapour saturation.

Deposition in step (ii) is preferably performed for at least 10 seconds, more preferably for at least 30 seconds. Preferably, deposition is continued for no longer than 12 minutes, more preferably no longer than 5 minutes.

Deposition times in step (iii) are int al. dependent on the metal-containing precursor used, the applied temperature, and the desired layer thickness. Deposition in step (iii) is preferably performed for at least 30 seconds, more preferably at least 1 minute, and most preferably at least 5 minutes. Preferably, deposition is continued for no longer than 2 hours, more preferably 1 hour, and most preferably 30 minutes. The deposited layer typically has a thickness of between 1 and 50 microns, and preferably between 3 and 30 microns.

Step (ii) and step (iii) of the process according to the present invention are preferably carried out at a pressure of at least 0.5 atm, more preferably of at least 0.8 atm. Preferably, the pressure is not higher than 2.0 atm, more preferably not higher than 1.3 atm. Most preferably, this step is performed at atmospheric pressure.

The present invention furthermore relates to a substrate with a multizone metallic coating obtainable by the above-disclosed process. In more detail, the present invention therefore also relates to a substrate having a multizone metallic coating comprising:
(A) a metallic core, which is surrounded by
(B) a multizone metallic coating comprising
   a zone (a) comprising
      (a1)) metal(s) of the metallic core,
      (a2) metal(s) originating from a metallic layer surrounding the metallic core, with the proviso that said metal(s) are less noble than the metallic material, which metal(s) have a gradual concentration change through this zone (a) with a concentration of less than 1 wt % at one end of the zone,
   a zone (b) comprising
      (b1) the metal(s) of the metallic core,
      (b2) the metal(s) of (a2),
      (b3) one or more metals selected from the group consisting of aluminium, magnesium, and zinc, with the proviso that said metal(s) are less noble than the metal(s) of the metallic material, which metal(s) have a gradual concentration change of aluminium, magnesium, and/or zinc through the zone (b) with a concentration of less than 1 wt % at one end of the zone,
   a zone (c) comprising
      (c1) the metal(s) of (a2), which metal(s) have a gradual concentration change through this zone (c) with less than 1 wt % concentration at one end of the zone,
      (c2) the metal(s) of (b3),
   and
   a zone (d) essentially consisting of the metal(s) of (b3).

It is noted that by the term “essentially consisting of” in the description of zone (d) is meant that at least 90 wt %, preferably at least 95 wt %, more preferably at least 97 wt % of zone (d) consists of the metal(s) of (b3), i.e. metals selected from the group consisting of aluminium, magnesium, and zinc.

The metallic core is preferably selected from the group consisting of unalloyed steel, low alloyed steel, high alloyed steel, iron, cast iron, copper, a copper alloy, nickel, a nickel alloy, titanium, a titanium alloy, alpha-titanium, beta-titanium, alpha-beta-titanium, gamma-titanium-aluminium, aluminium, cast aluminium, an aluminium alloy, magnesium, cast magnesium, a magnesium alloy, cobalt, a cobalt alloy, zinc, cast zinc, a zinc alloy, tin, and chromium.

The metallic layer is preferably selected from the group consisting of zinc, a zinc-nickel alloy, a zinc-iron alloy, a zinc-tin alloy, a zinc-chromium alloy, a zinc-magnesium alloy, a zinc-aluminium alloy, a zinc-aluminium-magnesium alloy, and magnesium.

The thickness of zone (a) of the multizone metallic coating is preferably at least 0.1 μm, the thickness of zone (b) preferably ranges from 0.5 μm to 25 μm, the thickness of zone (c) is preferably 25 μm or less, and the thickness of zone (d) is preferably 25 μm or less.

The present invention furthermore relates to the use of the substrate having a multizone coating in assemblies that are in contact with aggressive media such as chlorine, aggressive neutral media, media such as biodiesel, alcohols, fuel and/or cooling fluids; in assemblies that need to be painted and/or lacquered; in assemblies that are exposed to contact corrosion; in assemblies that need to be welded; in assemblies that are exposed to friction or wearing, or in assemblies that have to have resistance against sticking.

The present invention is elucidated by means of the following non-limiting Examples.

### EXAMPLE 1

### Formation of a Multizone Multi-Component Aluminium, Zinc, Iron System on Small Hollow Cylindrical Objects

A five-litre glass vessel that is part of equipment designed for the coating of small objects by Chemical Vapour Deposition (CVD) technique was charged with approximately 300 g of hollow cylindrical steel (cold heading, free cutting steel such as 22B2) objects. Each object was 5 mm in length and 5 to 8 mm in outer diameter weighing 0.7 to 1 g, electrochemically coated with a layer of zinc of 2 to 7 μm in thickness. Prior to loading, the objects were degreased, pickled, rinsed, and dried of residual water.

Once charged, the coating vessel was flushed with nitrogen to reduce the oxygen level to a sufficiently low value suitable for the applied CVD. In parallel with that, the metal objects, put in motion, were heated by an induction heating system to the temperature of 230-240° C. and kept at that level for a period of 5 minutes to ensure all used fluids from the previous steps were removed from the surface and in order for the head space desired for the CVD with the applied precursor to reach a sufficiently high temperature.

At the moment considered as the start of the formation of the desired multizone multi-component aluminium, zinc, iron system by combined effects of controlled metal diffusion and chemical vapour deposition, the objects were heated to a temperature of 365° C. at a heating rate of 30° C./min. At the moment the temperature of the objects reached 365° C., the introduction of the preheated CVD precursor (triethylaluminium) and nitrogen began and was continued until the end of the process. The temperature of 365° C. was maintained for a period of approximately 1 minute. This step was followed by cooling at a rate of 6° C./min until the temperature of the parts reached 340° C. Such temperature level was maintained for a period of 8 minutes, after which the dosing of the CVD precursor mixture was stopped. The last step was cooling at a rate of around 20° C./min down to 100° C. using cold inert low-boiling point fluid, followed by a slow cooling in nitrogen to the room temperature.

After the above-described treatment process, the evaluation of the formed multizone aluminium, zinc, iron metal alloy system on the treated objects was performed. The chemical composition was analyzed by scanning electron microscopy (SEM) outfitted with Energy-Dispersive X-ray spectroscopy detector (EDX). The formed coating consisted of a zone with minimal diffusion of Al and Zn into the base material (steel), followed by a zone of Al—Zn—Fe alloy, and finally an Al-rich alloy at the top that contained a negligible concentration of Fe. The total thickness of the formed coating system was on average 20 μm.

Furthermore, visual inspection of the presence of defects in the formed multicomponent metal system was done by microscopic evaluation under 1,000 times magnification as well as by using scanning electron microscopy (SEM). Minimal presence was found of the positive throwing power defects (edges thickening) or of defects where base material is exposed to the atmosphere. Furthermore, good adhesion of the formed multizone system to the base material and between the formed zones was found.

The objects were submersed into demineralized water for a period of 96 hours. Negligible corrosion of the objects was observed after that period. Also, another set of the objects was exposed to the salt spray test according to the standard procedure as defined in DIN50021-SS for a duration of 720 hours. No corrosion characterized by the red rust formation was noticed. In comparison to the objects coated applying the same procedure but where no zinc was present—hence a two component Al—Fe system—the corrosion resistance of the Al—Zn—Fe system was far superior.

### EXAMPLE 2

### Formation of a Multizone Multi-Component Aluminium, Zinc, Iron System on Small Solid Threaded Cylindrical Objects

The process as described in Example 1 was repeated but with approximately 1 kg of solid cylindrical steel (such as 1.4301 or 1.4305 steel) objects of 5 mm in length and 4 to 5 mm in outer diameter and having a thread through their length, weighing 0.4 g each, electrochemically covered with a layer of zinc of 2-7 μm in thickness. After the same preparation steps as in Example 1, the objects were heated by an induction heating system to a temperature of 240° C. and kept at that level for a period of 5 minutes to ensure all used fluids from the previous steps were removed from the surface and in order for the head space desired for the CVD with triethylaluminium/nitrogen mix being applied as precursor to reach a sufficiently high temperature.

At the moment considered as the start of the formation of the desired multizone multi-component aluminium, zinc, iron system by combined effects of controlled metal diffusion and chemical vapour deposition, the objects were heated to a temperature of 365° C. with a heating rate of 30° C./min. At the moment the temperature of the objects has reached 365° C., the introduction of the preheated CVD precursor began and was continued until the end of the process. The temperature of 365° C. was kept at this level for a period of around 2 minutes. This step was followed by cooling at a rate of circa 20° C./min until the temperature of the parts reached 340° C. Such temperature level was kept for a period of 10 minutes, after which the dosing of the CVD precursor mixture ended. The last step was cooling at a rate of around 20° C./min down to 100° C. using cold inert low-boiling point fluid, followed by a slow cooling in nitrogen to the room temperature. Finally, after this the parts were passivated by standard Cr(III) passivation treatment known to the persons skilled in the art.

After the above-described treatment process, the evaluation of the formed multizone multicomponent aluminium, zinc, iron metal system on the treated objects was performed. The chemical composition was analyzed by scanning electron microscopy (SEM) outfitted with Energy-Dispersive X-ray spectroscopy detector (EDX). The formed coating consisted of a zone with minimal diffusion of Al and Zn into the base material (steel), followed by a zone of Al—Zn—Fe alloy, and finally an Al-rich alloy at the top that contained a negligible concentration of Fe and a low concentration of Zn. The total thickness of the formed coating system was on average 8 μm.

Furthermore, visual inspection of the presence of defects in the formed multicomponent metal system was done by microscopic evaluation under 1,000 times magnification as well as by using scanning electron microscopy (SEM). Furthermore, good adhesion of the formed multizone system to the base material and between the formed zones was found.

Finally, the objects were submerged in demineralized water for a period of 8 days. No corrosion of the objects was observed after that period. In comparison to the objects coated applying the same procedure but where no zinc was present—hence a two component Al—Fe system—the corrosion resistance of the Al—Zn—Fe system was far superior.

### EXAMPLE 3

### Corrosion Performance of the Multizone Multi-Component Aluminium, Zinc, Iron System in Contact with the Cooling Fluid (Comparison with the Aluminium, Iron System)

Steel objects coated applying the procedure as described in the previous examples, and hence having a multizone multi-component Al, Zn, Fe coating as also described in those examples, were partially immersed in a vessel containing a typical engine cooling fluid (50:50 mixture by weight of silicate-free cooling fluid and water). In addition to those, the same steel objects coated with a layer of pure aluminium (similar coating thickness as for Al, Zn, Fe system), either passivated by one of the standard procedures known to the persons skilled in art, after aluminium deposition, or not passivated at all, were also submerged in the same vessel with the cooling fluid. It is emphasized that the objects with Al, Zn, Fe coating were not passivated. In total 14 different objects were involved in the test (different combinations of the metal coating and passivation procedures). The temperature of the cooling fluid was kept at 100° C. and atmospheric pressure was maintained.

After 500 h hours of exposure to the cooling fluid the objects were visually examined for the presence of white or red rust.

On the object coated with aluminium, not passivated, but also on five of the aluminium-coated and passivated objects, significant generation of red or white rust was observed. Four other passivated, aluminum-coated objects showed moderate white rust formation, whereas on the remaining three passivated, aluminum-coated objects low to moderate white rust formation was observed.

On the object with the Al, Zn, Fe coating no red and negligible white rust formation was found.

### COMPARATIVE EXAMPLE 4

### Comparison of the Aluminium Deposited by Exposing an Object to a Liquid Metal Alkyl Precursor (Liquid Phase Epitaxy—LPE) to the Chemical Vapour Deposition

A steel tube was heated to temperature of 340° C. by an electrically heated cartridge inserted inside the tube and sealed and the object was submerged into liquid triethylaluminium precursor at room temperature. The whole procedure was performed in a glove box in an inert atmosphere. The temperature of the object and of the precursor was monitored by thermocouples attached to the surface or submerged in the liquid.

After the submersion, the temperature of the object started decreasing, while the formation of precursor fumes and heating of the precursor liquid was observed. The dipping into the precursor (submerging, removing from liquid, reheating the tube to the starting temperature and again submerging) was repeated seven times in the inert atmosphere to keep the temperature of the tube not lower than 270° C. After that the tube was removed from the inert atmosphere and the formed deposit was characterized.

A very dark gray deposit was found at the surface of the tube that was submerged, whereas a silver coloured deposit was found just above the line of submersion where vapour phase deposition occurred. The deposit that came from the liquid phase deposition showed very poor quality and adhesion to the surface of the substrate, whereas the one from the vapour phase deposition was much better. This demonstrated that the quality of the deposit resulting from the submersion into a liquid precursor is significantly poorer than that of the vapour deposition.

### COMPARATIVE EXAMPLE 5

### Preparation of a Multizone Metallic Coating Comprising of Aluminium, Zinc and Steel Involving Chemical Vapor Deposition of Aluminium by Methods Described in Prior Art (Such as in WO 2005/028704) on Galvanized Nuts

The same vessel as described in Example 1 was charged with 1.5 kg of zinc-plated (galvanized) steel nuts. Prior to that, the parts were degreased using an organic solvent, etched in diluted hydrochloric acid and dried with acetone and under nitrogen. After parts were loaded into the vessel, the same steps as described in Example 1—inertization of the coating vessel using nitrogen, removal of the rest of the pretreatment fluids from the surface of the objects by heating the parts to a temperature of 200° C. and reaching the desired temperature of the head space—were applied.

This time the objects were heated to a coating temperature of 340° C. with no controlled heating rate, as described in the prior art. When the temperature of 340° C. was reached, introduction of the preheated CVD precursor (triethylaluminium in nitrogen) was initiated. The temperature of the objects was maintained at the level of 340° C. for the duration of the coating (30 minutes), after which the heating was switched off and objects left to cool down spontaneously by heat exchange with the surroundings. Hence, with no controlled cooling rate.

After the coating process, the evaluation of the formed coating was performed. Already visual observation identified very poor adhesion of the formed coating. Most of the top metallic layer could easily be peeled off from the substrate. Scanning electron microscopy (SEM) outfitted with Energy-Dispersive X-ray spectroscopy (EDX) has also been performed. It confirmed the poor adhesion and has shown that the delamination occurs at the boundary of Al/Zn and Zn/Fe.

Hence, by applying a prior art chemical vapor deposition method, a metallic coating comprising aluminium, zinc and steel of a very poor quality will be generated.

### COMPARATIVE EXAMPLE 6

### Preparation of a Multizone Metallic Coating Comprising of Aluminium, Zinc and Steel Involving Chemical Vapor Deposition of Aluminium by Methods Described in the Prior Art (Such as in WO 2005/028704) on Zinc Plated Small Hollow Cylindrical Objects

The vessel as described in Example 1 was charged with approximately 300 g of the same zinc plated hollow cylindrical steel objects as used in Example 1. The degreasing, pickling, rinsing and drying steps were applied to the objects prior to loading, followed by inertization of the coating vessel with nitrogen, removal of the rest of fluids from the surface of the objects by heating to the temperature of 230-240° C. and reaching the same temperature of the head space as in Example 1.

This time the objects were heated to a coating temperature of 320° C., as suggested in the prior art, with no controlled heating rate, followed by introduction of the preheated CVD precursor (triethylaluminium in nitrogen). The temperature of the objects was maintained at the level of 320° C. for the whole duration of coating (10 minutes), after which the heating was switched off and objects left to cool down spontaneously by heat exchange with the surroundings. Hence, with no controlled cooling rate.

After the coating process, evaluation of the formed coating was performed. Visual observation identified poor adhesion of the formed coating. Most of the top metallic layer could easily be peeled off from the substrate. Scanning electron microscopy (SEM) outfitted with Energy-Dispersive X-ray spectroscopy (EDX) has also been performed. As in Comparative Example 5, it confirmed poor adhesion and has shown that the delamination occurs at the boundary of Al/Zn and Zn/Fe.

Hence, by applying a prior art chemical vapor deposition method, a metallic coating comprising aluminium, zinc and steel of a very poor quality will be generated.

1. Process for preparing a substrate with a multizone metallic coating comprising the steps of
(i) heating a metallic material optionally comprising a metallic outer layer having a different composition than said metallic material to a temperature T1,
(ii) at T1, depositing over a period of between 10 seconds and 12 minutes a coating of aluminium, magnesium, and/or zinc onto said metallic material via metal organic chemical vapour deposition using one or more metal-containing precursors selected from the group consisting of aluminium-containing precursors and/or magnesium-containing precursors and/or zinc-containing precursors, with T1 being a temperature at which the rate of diffusion of the deposited metal(s) and metal(s) of the metallic material and/or metallic outer layer is higher than or equal to the deposition rate of the deposited metal(s) but which is lower than the melting point of the metallic material or the metallic outer layer, or which is lower than the melting point of the formed metallic coating, whichever melting point is the lowest, with the proviso that the metal composition at the exterior of the metallic material is not identical to the composition of the deposited metal(s), and
(iii) cooling down to a temperature T2 and continuing the deposition, with T2 being a temperature at which the rate of diffusion of the metals is lower than the deposition rate of the metal(s), but which is at least a temperature at which the deposition rate of the metal(s) being deposited is higher than 0.2 μm per minute.

2. Process according to claim 1 wherein the substrate is a metallic material selected from the group consisting of unalloyed steel, low alloyed steel, high alloyed steel, iron, cast iron, copper, a copper alloy, nickel, a nickel alloy, titanium, a titanium alloy, alpha-titanium, beta-titanium, alpha-beta-titanium, gamma-titanium-aluminium, aluminium, cast aluminium, an aluminium alloy, magnesium, cast magnesium, a magnesium alloy, cobalt, a cobalt alloy, zinc, cast zinc, a zinc alloy, tin, and chromium.

3. Process according to claim 1 wherein the metallic material comprises a metallic layer selected from the group consisting of zinc, a zinc-nickel alloy, a zinc-iron alloy, a zinc-tin alloy, a zinc-chromium alloy, a zinc-magnesium alloy, a zinc-aluminium alloy, a zinc-aluminium-magnesium alloy, and magnesium.

4. Process according to claim 1 wherein the substrate is selected from the group consisting of fasteners, nuts, bolts, screws, nails, rivets, pins, clamps, ferrules, clips, tags, metal sheets, aligning disks, balls, (automobile) gearbox parts, (automobile) suspension parts, wheel rims, exhaust manifolds, brake discs, metal wire, tubes, and metal coil.

5. Process according to claim 1 with the metallic material being zinc coated steel and with the metal-containing precursor being triethylaluminium, wherein temperature T1 is 340-400° C. and wherein temperature T2 is at least 300° C.

6. Process according to claim 1 wherein step (i) is performed over a period of maximally 48 hours, preferably maximally 10 hours, more preferably maximally 1 hour, step (ii) is performed over a period of 10 seconds to 12 minutes, and step (iii) is performed over a period of 30 seconds to 2 hours.

7. Process according to claim 1 wherein the metal-containing precursor is selected from the group consisting of aluminium alkyls, magnesium alkyls, zinc alkyls, aluminium alkylamides, magnesium alkylamides, zinc alkylamides, and volatile aluminium, magnesium or zinc organometallics comprising one or more cyclopentadienyl ligands.

8. A substrate having a multizone metallic coating comprising:
(A) a metallic core, which is surrounded by
(B) a multizone metallic coating comprising
a zone (a) comprising
(a1)) metal(s) of the metallic core,
(a2) metal(s) originating from a metallic layer surrounding the metallic core, with the proviso that said metal(s) are less noble than the metallic material, which metal(s) have a gradual concentration change through this zone (a) with a concentration of less than 1 wt % at one end of the zone,
a zone (b) comprising
(b1) the metal(s) of the metallic core,
(b2) the metal(s) of (a2),
(b3) one or more metals selected from the group consisting of aluminium, magnesium, and zinc, with the proviso that said metal(s) are less noble than the metal(s) of the metallic material, which metal(s) have a gradual concentration change of aluminium, magnesium, and/or zinc through the zone (b) with a concentration of less than 1 wt % at one end of the zone,
a zone (c) comprising
(c1) the metal(s) of (a2), which metal(s) have a gradual concentration change through this zone (c) with less than 1 wt % concentration at one end of the zone,
(c2) the metal(s) of (b3), and
a zone (d) essentially consisting of the metal(s) of (b3).

9. A substrate according to claim 8 wherein the metallic material selected from the group consisting of unalloyed steel, low alloyed steel, high alloyed steel, iron, cast iron, copper, a copper alloy, nickel, a nickel alloy, titanium, a titanium alloy, alpha-titanium, beta-titanium, alpha-beta-titanium, gamma-titanium-aluminium, aluminium, cast aluminium, an aluminium alloy, magnesium, cast magnesium, a magnesium alloy, cobalt, a cobalt alloy, zinc, cast zinc, a zinc alloy, tin, and chromium.

10. A substrate according to claim 8 wherein the metallic layer is selected from the group consisting of zinc, a zinc-nickel alloy, a zinc-iron alloy, a zinc-tin alloy, a zinc-chromium alloy, a zinc-magnesium alloy, a zinc-aluminium alloy, a zinc-aluminium-magnesium alloy, and magnesium.

11. A substrate according to claim 8 wherein the thickness of zone (a) of the multizone metallic coating is at least 0.1 μm, the thickness of zone (b) ranges from 0.5 μm to 25 μm, the thickness of the zone (c) is equal to or lower than 25 μm, and the thickness of the zone (d) is equal to or lower than 25 μm.

12. A method comprising preparing the substrate of claim 8 in assemblies that are in contact with aggressive media such as chlorine, aggressive neutral media, media such as biodiesel, alcohols, fuel and/or cooling fluids; in assemblies that need to be painted and/or lacquered; in assemblies that are exposed to contact corrosion; in assemblies that need to be welded; in assemblies that are exposed to friction or wearing, or in assemblies that have to have resistance against sticking.
